(19) United States
(12) Patent Application Publication
(10) Pub. No.: US 2010/0042368 A1
(43) Pub. Date: Feb. 18, 2010

(54) MANAGING MACHINE TOOL AND AUXILIARY EQUIPMENT PREVENTATIVE MAINTENANCE

(76) Inventors: Randolph LOVELACE, Roscoe, IL (US); Mark Brownhill, Earlysville, VA (US); Wayne Kotania, Gordonsville, VA (US)

Correspondence Address: General Electric Company;GE Global Patent Operation, PO Box 861, 2 Corporate Drive, Suite 648, Shelton, CT, 06484, US

(21) Appl. No.: 12/192,993

(22) Filed: Aug. 16, 2008

(51) Int. Cl. G06F 15/00

(52) U.S. Cl. 702/184

(57) ABSTRACT

A method for managing production facility preventative maintenance is described. The method is performed using a computer system coupled to a database. The method includes receiving operation data from at least one machine controller and at least one auxiliary equipment controller, wherein the operation data corresponds to operation of at least one of machine tool and at least one auxiliary system that supports the production facility operation. The method also includes converting the operation data into usage data and determining a required preventative maintenance by comparing the usage data to stored preventative maintenance data. The method also includes outputting at least one of a percentage of life remaining and a notification of required preventative maintenance.

### BACKGROUND OF THE INVENTION

The field of the invention relates generally to managing machine and auxiliary equipment preventative maintenance, and more particularly, to facilitating optimized maintenance schedules for a machine and auxiliary equipment that supports operation of the machine.

A production facility, for example a factory or manufacturing plant, typically includes machines as well as auxiliary equipment that support the machines. Processor-based controls, such as a computer numerical control (CNC) and a programmable logic control (PLC) may be used to control machine tools and the equipment that support the machine tools. Typically, the controls provide an operator of the machine tool or auxiliary equipment with information that allows the operator to monitor and adjust the operation if necessary.

In addition to controlling factory operation, the operator of a factory must ensure that proper maintenance actions are performed on the machines and equipment. Typically, preventative maintenance of machines and auxiliary equipment is tracked and scheduled separately. Preventative maintenance may be scheduled to take place at predetermined time intervals, regardless of the actual usage of the machine or equipment during that time period. For example, preventative maintenance may be performed on a machine once every month. Scheduling preventative maintenance in this fashion may lead to unnecessary down-time if the machine is not operated a typical amount during the time period. Unnecessary down-time reduces the efficiency of a factory's operation. Alternatively, preventative maintenance may be monitored by the operator, who collects and records operating information in order to schedule preventative maintenance actions.

### BRIEF DESCRIPTION OF THE INVENTION

In one aspect, a method for managing production facility preventative maintenance is provided. The method is performed using a computer system coupled to a database. The method includes receiving operation data from at least one machine controller and at least one auxiliary equipment controller, wherein the operation data corresponds to operation of at least one machine tool and at least one auxiliary system that supports the production facility operation. The method also includes converting the operation data into usage data and determining a required preventative maintenance by comparing the usage data to stored preventative maintenance data. The method also includes outputting at least one of a percentage of life remaining and a notification of required preventative maintenance.

In another aspect, a system for managing preventative maintenance of at least one machine tool and at least one auxiliary system within a production facility is provided. The system includes at least one machine controller configured to monitor an operation of at least one component of the at least one machine tool, at least one auxiliary equipment controller configured to monitor an operation of the at least one auxiliary system, and a computer coupled to the at least one machine controller and the at least one auxiliary equipment controller. The computer is configured to receive operation data from the at least one machine controller and the at least one auxiliary equipment controller and to convert the operation data into usage data of the at least one component of the at least one machine tool and the at least one component of the at least one auxiliary system. The computer is further configured to determine required preventative maintenance by comparing the usage data to stored preventative maintenance data, and output to a user of the system a notification of required preventative maintenance.

In another aspect, a server system for managing production facility preventative maintenance is provided. The system includes a client system comprising a browser, a centralized database for storing information, and a server system configured to be coupled to the client system and the database. The server is further configured to receive operation data from at least one machine controller and at least one auxiliary equipment controller. The operation data includes data from at least one machine tool and at least one auxiliary system. The server is further configured to convert the operation data into usage data of the at least one machine tool and the at least one auxiliary system and determine required preventative maintenance by comparing the usage data to stored preventative maintenance data. The server is also configured to output to the client system a notification of required preventative maintenance.

In yet another aspect, a computer program embodied on a computer readable medium for managing production facility preventative maintenance is provided. The program includes at least one code segment that receives operation data from at least one machine controller and at least one auxiliary equipment controller, converts the operation data into usage data of at least one machine tool and at least one auxiliary system that supports operation of the at least one machine tool, and determines required preventative maintenance by comparing the usage data to stored preventative maintenance data. The program also includes at least one code segment that outputs a notification of required preventative maintenance.

### BRIEF DESCRIPTION OF THE DRAWINGS

FIG. 1 is a simplified block diagram of an exemplary embodiment of a server architecture of a system in accordance with one embodiment of the present invention.

FIG. 2 is an expanded block diagram of an exemplary embodiment of a server architecture of a system in accordance with one embodiment of the present invention.

FIG. 3 is a block diagram of an exemplary embodiment of a preventative maintenance monitoring system for determining actual use of machines and auxiliary equipment within a production facility.

FIG. 4 is a flow chart illustrating a method for monitoring and scheduling preventative maintenance of machines and auxiliary equipment within a production facility.

### DETAILED DESCRIPTION OF THE INVENTION

The following detailed description illustrates embodiments of the invention by way of example and not by way of limitation. It is contemplated that embodiments described herein have general application to management of machine tools and utilities preventative maintenance operations.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

As described herein, an asset management system for managing preventative maintenance of a production facility, for example, a factory or manufacturing plant, includes an interface, for example, a web-based interface, for managers and users that facilitates tracking the life of an asset and alerting a predetermined user upon the expiration of the life. An asset's life, as described herein, is the time period between preventative maintenance actions. The system provides table-based reports of overall status of asset life utilization and histories of the maintenance performed on assets. Each of these reports can be filtered by the production line and production units on which the assets exist. The asset management system facilitates monitoring and recording of the large amount of operating information necessary to determine optimal preventative maintenance schedules of machines and auxiliary equipment that is included in the production facility.

The interface allows for customized preventative maintenance management, including preventative maintenance management of machines and also the auxiliary equipment that supports operation of the machines. A plurality of life-measurements may be tracked so that a user is provided with information that allows for the most accurate determination of when preventative maintenance is required. A notification is provided to the user as assets near the end of their expected life, as they exceed their life, and periodically thereafter if the assets continue to exceed their defined life limits. The periodic notifications allow for an escalation of notifications to personnel in a wider range of influence to help ensure the maintenance is performed.

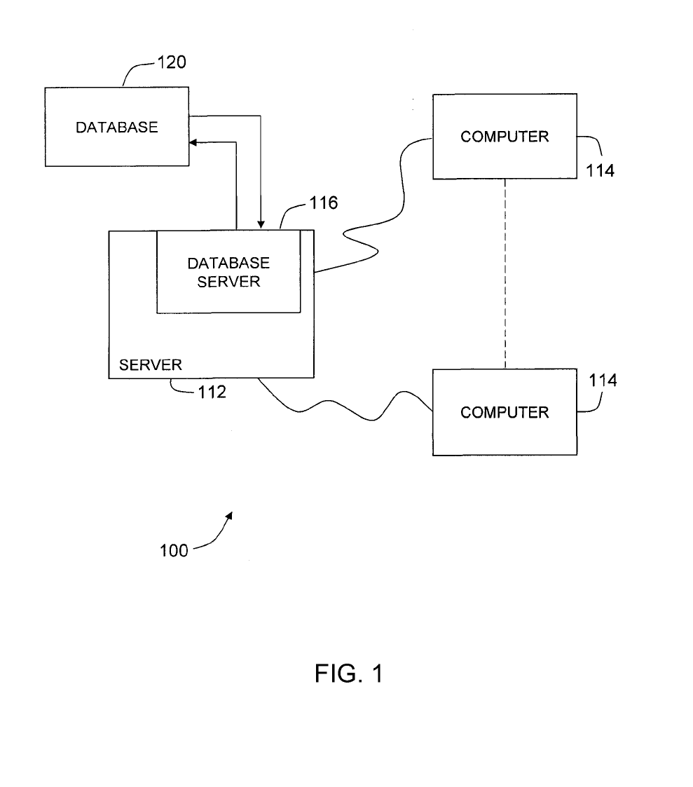

FIG. 1 is a simplified block diagram of an exemplary system 100 in accordance with one embodiment of the present invention. In one embodiment, system 100 is a preventative maintenance management system for monitoring the usage of machines and auxiliary equipment included in a factory or production facility, and tracking actual use of the machines and auxiliary equipment, and is operable to implement the techniques described herein.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any device capable of interconnecting to the Internet including a web-based phone, personal digital assistant (PDA), or other web-based connectable equipment. A database server 116 is connected to a database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

As discussed herein, database 120 stores information relating to factory operation and preventative maintenance management for each of a plurality of machines, and for the auxiliary equipment that is also included in the factory or production facility. Database 120 may also store information on users of system 100, for example, names and contact information of maintenance personnel. Database 120 may also store data corresponding to user selections, for example, regarding maintenance personnel assigned to perform a particular preventative maintenance task or the method of communicating a preventative maintenance task reminder to the assigned maintenance personnel.

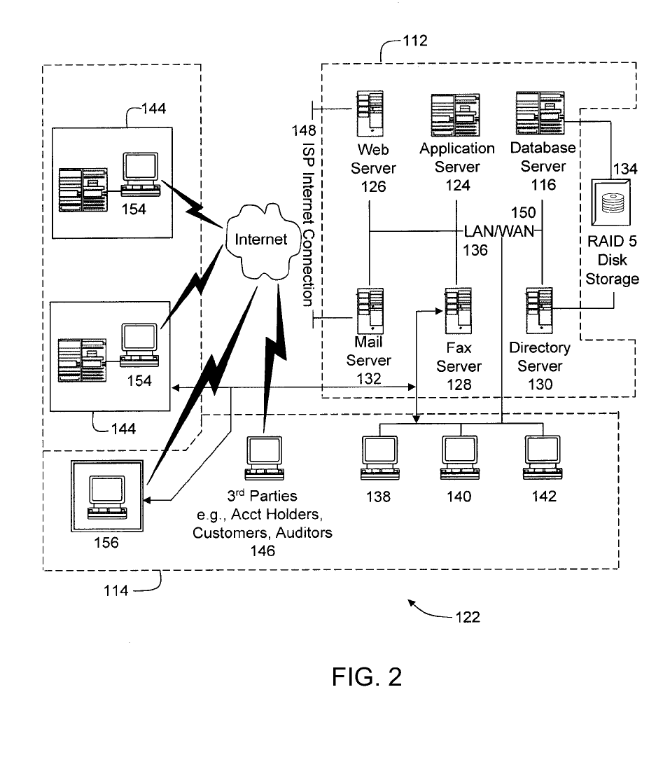

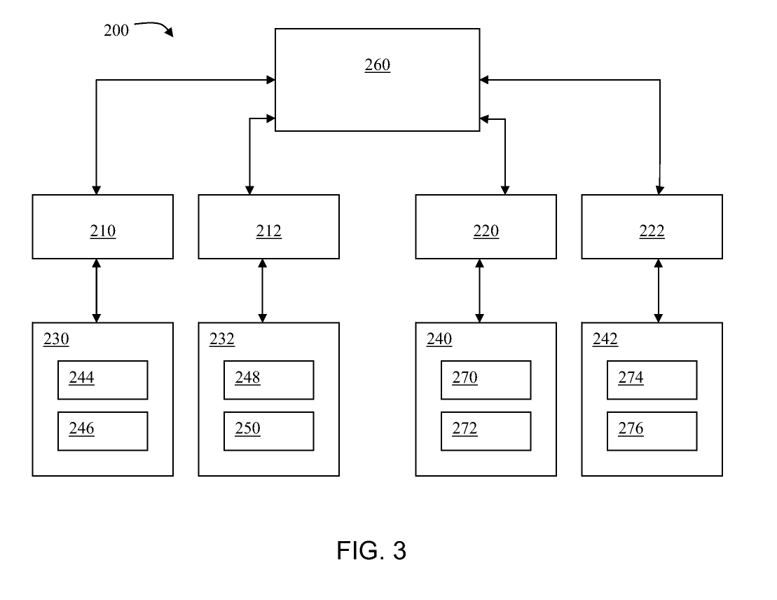

FIG. 2 is an expanded block diagram of an exemplary embodiment of a server architecture of a system 122 in accordance with one embodiment of the present invention. Components in system 122, identical to components of system 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an internet link or are connected through an intranet.

Each workstation, 138, 140, and 142 comprises a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., factor operators, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

FIG. 3 is a block diagram of an exemplary embodiment of a preventative maintenance management system 200 for monitoring actual use of machines and auxiliary equipment included in a production facility, and determining when to perform preventative maintenance actions. In the exemplary embodiment, system 200 includes machine controllers 210 and 212 and auxiliary equipment controllers 220 and 222. However, system 200 may include any number of machine controllers and/or auxiliary equipment controllers and function as described herein. The machine controllers 210 and 212 are coupled to at least one machine, for example, machines 230 and 232.

As described herein, machines 230 and 232 comprise at least one of a machine tool and a production machine, which may be interchangeably referred to herein as machine tools. For example, machines 230 and 232 may, include machines involved in the manufacture, assembly, and/or packaging of a product or system. More specifically, in certain embodiments, machines 230 and 232 comprise a computer numerical control (CNC) machine, a welding machine, a friction welder, an industrial laser, a drill system, a line transfer machine, and a dial machine. In at least one example where machine 230 is a CNC machine, machine controller 210 is a CNC controller configured to control machine 230, and auxiliary equipment controller 220 is a programmable logic controller (PLC) configured to control a piece of auxiliary equipment that supports the CNC machine.

In the exemplary embodiment, auxiliary equipment controllers 220 and 222 are configured to control and monitor operation of at least one piece of auxiliary equipment, for example, auxiliary system 240 and auxiliary system 242. In the exemplary embodiment, auxiliary systems 240 and 242 are systems within the manufacturing facility that support operation of machines 230 and 232, however, auxiliary systems 240 and 242 may be any component or system that supports operation of the factory or production facility. For example, auxiliary systems 240 and 242 may be material handling machines for transport of a component between machines 230 and 232, a coolant system for the manufacturing facility, a central cutting fluid system that provides cutting fluid to machines 230 and 232, or an industrial robot that delivers materials to machines 230 and 232. However, auxiliary systems 240 and 242 may be any systems that support operation of machine tools 230 and 232 or the factory in general, as described herein.

In the exemplary embodiment, machines 230 and 232 include a plurality of components, for example, a first component 244, a second component 246, a third component 248, and a fourth component 250. Components 244, 246, 248, and 250 may include, but are not limited to including, a spindle motor, a rotating axel, a hydraulics system, and a lubrication system. Components 244 and 246 each perform a function in order to accomplish the manufacturing or assembly step that machine 230 is configured to perform. Similarly, components 248 and 250 each perform a function in order to accomplish the manufacturing or assembly step that machine 232 is configured to perform. Components 244, 246, 248, and 250 may be any machine component or system that enables machines 230 and 232 to operate as described herein. In the exemplary embodiment, in addition to controlling operation of machines 230 and 232, machine controller 210 is also configured to monitor the operation of machines 230 and 232, including operation of the individual components 244, 246, 248, and 250 that are included in each of machines 230 and 232. Similarly, auxiliary systems 240 and 242 include a plurality of components, for example, a fifth component 270, a sixth component 272, a seventh component 274, and an eighth component 276. Although shown in FIG. 3 as including two components, machines 230 and 232, as well as auxiliary systems 240 and 242, may include any number of components that enable machines 230 and 232 and auxiliary systems 240 and 242 to function as described herein.

In the exemplary embodiment, machine controllers 210 and 212 and auxiliary controllers 220 and 222 are personal computers (PC) running human-machine interface (HMI) software. In an alternative embodiment, machine controller 210 monitors, and controls operation of, multiple machines, for example, both machine 230 and machine 232. In some examples, rather than running on a separate device, machine controller 210 may be included within machine 230.

In the exemplary embodiment, machine controllers 210 and 212, and auxiliary equipment controllers 220 and 222, monitor operation of machines 230 and 232 and auxiliary systems 240 and 242, respectively. Machine controllers 210 and 212 and auxiliary equipment controllers 220 and 222 provide data corresponding to the operation of machines 230 and 232 and auxiliary systems 240 and 242 to a computer 260. In the exemplary embodiment, computer 260 is configured to store a predetermined life for each of machines 230 and 232 and auxiliary systems 240 and 242. In the exemplary embodiment, computer 260 is also configured to store a predetermined life for each of components 244, 246, 248, 250, 270, 272, 274, and 276. The time period that defines a life depends on the component 244, 246, 248, 250, 270, 272, 274, and 276. A user selects the time period that defines the life based on the type of time period that will facilitate determining the optimal time for preventative maintenance. Accordingly, computer 260 may store an elapsed time that corresponds to the amount of time since a predetermined starting point of each of machines 230 and 232 and auxiliary systems 240 and 242, including each individual component 244, 246, 248, 250, 270, 272, 274, and 276. In at least one example, the predetermined starting point is the previous preventative maintenance action on the monitored component. Computer 260 may also store a “power-on” time of each of machines 230 and 232, auxiliary systems 240 and 242, and the corresponding individual component 244, 246, 248, 250, 270, 272, 274, and 276. The power-on time accumulates when the individual component is supplied with power.

Computer 260 may also monitor a running time of each of machines 230 and 232, auxiliary systems 240 and 242, and the corresponding individual component 244, 246, 248, 250, 270, 272, 274, and 276. The running time of each monitored component accumulates when the component is performing a function. Computer 260 may also monitor a cutting time of any of the machines 230 and 232, including components 244, 246, 248, and 250, that perform cutting. Cutting time accumulates when the machine or component is cutting. Computer 260 may also monitor a “spindle-on” lime. The spindle-on time accumulates when a spindle within machines 230 and 232 or auxiliary systems 240 and 242 is running. The above described time periods are listed as examples only, and any time period may be monitored that enables system 200 to function as described herein.

Monitoring the above described specific time periods facilitates accurately determining an actual usage of machines 230 and 232, auxiliary systems 240 and 242, and the corresponding individual component 244, 246, 248, 250, 270, 272, 274, and 276. The actual usage of the components is compared to stored preventative maintenance requirements to determine when a preventative maintenance action should be performed. The actual usage of the components also facilitates more accurately determining the usable life of the components that make up a production facility. The actual usage of the components also provides a user with additional data with which to predict the life of components.

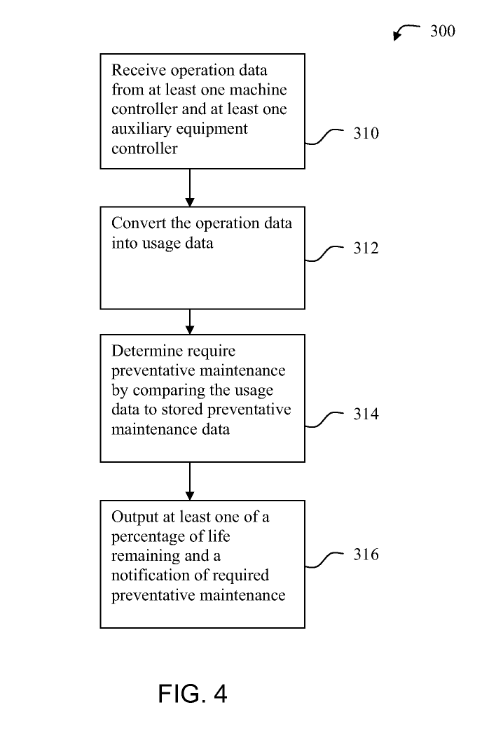

FIG. 4 is a flow chart 300 illustrating a method for preventative maintenance management of components within a production facility. More specifically, flow chart 300 illustrates a method for monitoring and scheduling preventative maintenance of machines and auxiliary equipment within a factory or production facility. The time between preventative maintenance actions is referred to herein as a life of the machine, auxiliary system, or component being monitored. As described above, the life is based on the actual usage, which may be based on the elapsed usage time, the power-on time, the running time, the cutting time, the spindle-on time, or any other usage time that allows the asset management system to function as described herein. The actual usage being monitored may include the usage of machines 230 and 232 and auxiliary systems 240 and 242. The actual usage being monitored may also include the usage of individual components 244, 246, 248, 250, 270, 272, 274, and 276.

In the exemplary embodiment, the method includes receiving 310 operation data from machine controllers 210 and 212 (shown in FIG. 3) and auxiliary equipment controllers 220 and 222 (shown in FIG. 3) at computer 260. In certain embodiments, the methods described herein can be run on a single PC 260, with a data server, SQL database, and webserver configured on the single PC. In alternative embodiments, a customer's existing web and SQL hardware servers can be used, with the data server on a separate PC. The system can also be integrated into a GE Fanuc Proficy MTE (Machine Tool Efficiency) system. Furthermore, in other embodiments, computer 260 may be remotely located, for example, in the manner described above with respect to FIG. 2. The operation data includes data corresponding to the operation of machines 230 and 232, and more specifically, to the operation of components 244, 246, 248, and 250. The operation data also includes data corresponding to the operation of auxiliary systems 240 and 242, as well as components 270, 272, 274, and 276. Operation data may include data corresponding to elapsed usage time, power-on time, running time, cutting time, and spindle-on time of the components being monitored.

The method also includes converting 312 the operation data into usage data. Converting 312 the operation data into usage data requires discrete knowledge of signals provided by machine controllers 210 and 212, and auxiliary equipment controllers 220 and 222, and/or how to extract those signals to computer 260. In the exemplary embodiment, machine controllers 210 and 212 and auxiliary equipment controllers 220 and 222 utilize an HMI, for example, Proficy Cimplicity, available from GE Fanuc of Charlottesville, Va., to collect operation data in real time, and store accumulated utilization time values each hour to a local SQL database instance. A master SQL database retrieves the collected values on a daily basis, and processes the results for storage and calculations of life utilization. In the exemplary embodiment, operation data is stored in computer 260 as units of “seconds of usage.” In the exemplary embodiment, usage is not pro-rated based upon a load applied to the measured device, but rather works as a simple countdown clock.

The method also includes determining 314 at least one of a required preventative maintenance and a percentage of life remaining by comparing the usage data to stored preventative maintenance data. Stored preventative maintenance data may include the life of an individual component being monitored, a technician responsible for performance of preventative maintenance on the component, and contact information for the technician and the technician's supervisor. In one specific example, the life of a CNC machine cutting tool is two-hundred hours of cutting time. Preventative maintenance data is stored in a memory of computer 260 that includes the requirement that the CNC machine cutting tool receive preventative maintenance after two-hundred hours of cutting time. Machine controller 210 provides computer 260 with operating data corresponding to operation of the CNC machine cutting tool and computer 260 converts 312 the operating data to an accumulated time that the CNC machine has been cutting an object being manufactured. The percentage of life remaining is tracked and once the accumulated time that the CNC machine has been cutting reaches two-hundred hours, it is determined 314 that preventative maintenance on the CNC machine cutting tool is required.

The method also includes outputting 316 a notification of required preventative maintenance to a user of system 200. In the exemplary embodiment, outputting 316 notification of required preventative maintenance includes providing the notification to a display device viewable by a user. The notification of required preventative maintenance may include outputting 316 a real-time percentage of use, which is the percentage of the preventative maintenance time period that has accrued. For example, a display device may indicate to a user that the CNC machine cutting tool is ninety percent through the cutting time the tool is able to perform before preventative maintenance is required. Indicating required preventative maintenance allow s managers and technicians to understand when a device is nearing its preventive maintenance date, and to schedule preventative maintenance operations. In one example, a traffic signal-like graphic is provided for each production facility component being monitored. If a green light on the traffic signal graphic is lit, it indicates to the user that the corresponding component has recently received preventative maintenance. If a yellow light on the traffic signal graphic is lit, it indicates to the user that the component is approximately half-way between a previous preventative maintenance action and requiring another preventative maintenance action, or that a preventative maintenance action has been scheduled for an upcoming date. If a red light on the traffic signal graphic is lit, it indicates to the user that a preventative maintenance action will soon be required for the corresponding component, or preventative maintenance is currently needed.

Outputting 316 notification of required preventative maintenance may also include automated notifications via electronic mail to a predetermined electronic mail address or automated notifications to a predetermined phone number when a component reaches a predetermined percentage of life. In the example described above, when CNC machine cutting tool has reached one-hundred percent of the cutting time the tool is able to perform before preventative maintenance is required, an electronic mail notification informs managers that preventative maintenance must be performed. Also, if the CNC machine cutting tool is used further, notifications may be sent to managers in an escalating format, increasing the number of upper-level managers who are informed of the maintenance requirements that have yet to be met. Remaining life for other components being monitored may be 232473 included in the automated notification to allow the user to optimize maintenance on a particular machine tool or auxiliary equipment.

Determining 314 required preventative maintenance may also include estimating the next preventative maintenance date based on past use of the component. A system administrator user can configure lines, asset types, maintenance actions, maintenance technicians, email lists, users and user privileges for the system. A general user can enter preventive maintenance actions, reset life, and view current and historical maintenance status of components.

The preventative maintenance management system described above allows users to schedule preventative maintenance operations on their machines and auxiliary equipment based upon the actual usage of components of the machines. Scheduling by a simple calendar often leads to maintenance done too late to protect the component, or maintenance done too early to allow for cost-efficient utilization of that same component. Additionally, by being able to see what other nearby components may require maintenance, multiple actions can be performed in a single “machine downtime” period, which facilitates reducing the number of work stoppages for maintenance work. In transfer line operations, being able to see what other components in the same line are nearing their preventative maintenance dates, the entire line can benefit from fewer maintenance periods, which are planned in advance of their need according to scheduling and resource availability.

The preventative maintenance management system described herein is machine tool manufacturer independent, therefore, machines and auxiliary equipment manufactured by different companies may be included within system 200 (shown in FIG. 3). By managing multiple machines and the auxiliary equipment that support operation of the machines and production facility in general, users are not tied to a specific machine tool controller, or tied to a system which generates maintenance work orders but that does not understand how that single work order could be optimized by doing other preventative maintenance actions at the same time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for managing production facility preventative maintenance, said method performed using a computer system coupled to a database, said method comprising:
receiving operation data from at least one machine controller and at least one auxiliary equipment controller, wherein the operation data corresponds to operation of at least one machine tool and at least one auxiliary system that supports the production facility operation;
converting the operation data into usage data;
determining required preventative maintenance by comparing the usage data to stored preventative maintenance data; and
outputting at least one of a percentage of life remaining and a notification of required preventative maintenance.

2. A method in accordance with claim 1 further comprising configuring the at least one machine controller and the at least one auxiliary, equipment controller to monitor the operation of a plurality of individual components that are included within the machine tool and the auxiliary system.

3. A method in accordance with claim 1 further comprising configuring the at least one machine controller to monitor the operation of at least one of a spindle component, a cutting tool, a hydraulic pump, a battery, and a fuse.

4. A method in accordance with claim 1 further comprising configuring the at least one auxiliary equipment controller to monitor the operation of at least one of a coolant system, a cutting fluid system, and a driver cylinder.

5. A method in accordance with claim 1 wherein receiving operation data comprises receiving at least one of elapsed usage time data, power-on time data, running time data, cutting time data, and spindle-on time data.

6. A method in accordance with claim 2 further comprising storing preventative maintenance data comprising at least one of a maximum elapsed usage time, a maximum power-on time, a maximum running time, a maximum cutting time, and a maximum spindle-on time between preventative maintenance actions for the at least one machine tool, the at least one auxiliary system.

7. A method in accordance with claim 1 wherein outputting notification of required preventative maintenance comprises at least one of:
outputting the notification of required preventative maintenance to a display device viewable by the user; and
sending at least one of an electronic message to a predetermined electronic mail address and an electronic message to a predetermined phone number.

8. A system for managing preventative maintenance of at least one machine tool and at least one auxiliary system within a production facility, said system comprising:
at least one machine controller configured to monitor an operation of at least one component of said at least one machine tool;
at least one auxiliary equipment controller configured to monitor an operation of at least one component of said at least one auxiliary system;
a computer coupled to said at least one machine controller and said at least one auxiliary equipment controller, said computer configured to:
receive operation data from said at least one machine controller and said at least one auxiliary equipment controller;
convert the operation data into usage data of said at least one component of said at least one machine tool and said at least one component of said at least one auxiliary system;
determine required preventative maintenance by comparing the usage data to stored preventative maintenance data; and
output to a user of said system a notification of required preventative maintenance.

9. A system in accordance with claim 8 wherein said machine controller is configured to monitor the operation of at least one of a spindle component, a cutting tool, a hydraulic pump, a battery, and a fuse.

10. A system in accordance with claim 8 wherein said auxiliary equipment controller is configured to monitor the operation of at least one of a coolant system, a cutting fluid system, and a drive cylinder.

11. A system in accordance with claim 8 wherein said computer is further configured to convert the operation data from said at least one machine controller and said at least one auxiliary equipment controller to at least one of elapsed usage time data, power-on time data, running time data, cutting time data, and spindle-on time data.

12. A system in accordance with claim 8 wherein said computer is further configured to store preventative maintenance data comprising at least one of a maximum elapsed usage time, a maximum power-on time, a maximum running time, a maximum cutting time, and a maximum spindle-on time between preventative maintenance actions.

13. A system in accordance with claim 8 wherein said computer is further configured to at least one of:
output the notification of required preventative maintenance to a display device viewable by the user; and
send at least one of an electronic message to a predetermined electronic mail address and an electronic message to a predetermined phone number.

14. A server system for managing production facility preventative maintenance, said system comprising:
a client system comprising a browser;
a centralized database for storing information; and
a server system configured to be coupled to said client system and said database, said server further configured to:
receive operation data from at least one machine controller and at least one auxiliary equipment controller, the operation data comprising data from at least one machine tool and at least one auxiliary system;
convert the operation data into usage data of the at least one machine tool and the at least one auxiliary system;
determine required preventative maintenance by comparing the usage data to stored preventative maintenance data; and
output to said client system a notification of required preventative maintenance.

15. A server system in accordance with claim 14 wherein the machine controller is configured to monitor the operation of said machine tool and individual components included within said machine tool.

16. A server system in accordance with claim 14 wherein the auxiliary equipment controller is configured to monitor the operation of said auxiliary system and individual components included within said auxiliary.

17. A server system in accordance with claim 14 wherein said server is further configured to:
convert the operation data to at least one of elapsed usage time data, power-on time data, running time data, cutting time data, and spindle-on time data; and
store preventative maintenance data comprising at least one of a maximum elapsed usage time, a maximum power-on time, a maximum running time, a maximum cutting time, and a maximum spindle-on time.

18. A server system in accordance with claim 14 wherein said server is further configured to output the notification of required preventative maintenance to at least one of a display device viewable by the user, and an electronic mail application configured to send an electronic message to a predetermined electronic mail address.

19. A computer program embodied on a computer readable medium for managing production facility preventative maintenance, said program comprising at least one code segment that:
receives operation data from at least one machine controller and at least one auxiliary equipment controller;
converts the operation data into usage data of at least one machine tool and at least one auxiliary system that supports operation of the at least one machine tool;
determines required preventative maintenance by comparing the usage data to stored preventative maintenance data; and
outputs a notification of required preventative maintenance.

20. A computer program in accordance with claim 19 further comprising at least one code segment that stores the operation data from the at least one machine controller and the at least one auxiliary equipment controller, wherein the operation data corresponds to operation of a plurality of components included within the at least one machine tool and the at least one auxiliary system.

21. A computer program in accordance with claim 20 wherein the plurality of components comprises at least one of a spindle component, a cutting tool, a hydraulic pump, a battery a fuse, a coolant system, a cutting fluid system, and a driver cylinder.

22. A computer program in accordance with claim 20 further comprising at least one code segment that converts the operation data of the plurality of components to at least one of elapsed usage time data, power-on time data, running time data, cutting time data, and spindle-on time data.

23. A computer program in accordance with claim 19 further comprising at least one code segment that stores preventative maintenance data comprising at least one of a maximum elapsed usage time, a maximum power-on time, a maximum running time, a cutting time, and a spindle-on time.

24. A computer program in accordance with claim 19 further comprising at least one code segment that outputs the notification of required preventative maintenance to at least one of a display device viewable by the user, and an electronic mail application configured to send an electronic message to a predetermined electronic mail address.
